(19) United States
(12) Patent Application Publication
(10) Pub. No.: US 2004/0100086 A1
(43) Pub. Date: May 27, 2004

(54) Spine-indexing device

(76) Inventor: Fei-Chen Lee, Yung He City (TW)

Correspondence Address: KNOBLE, YOSHIDA & DUNLEAVY, EIGHT PENN CENTER, SUITE 1350, 1628 JOHN F KENNEDY BLVD, PHILADELPHIA, PA, 19103, US

(21) Appl. No.: 10/304,728

(22) Filed: Nov. 26, 2002

(51) Int. Cl. B42F 21/00

(52) U.S. Cl. 283/36

(57) ABSTRACT

A spine-indexing device for indexing easily in the vertical direction while the spine-indexing device is put on a shelf is provided. The spine-indexing device includes a first piece having an edge, a second piece extending from the edge; and a spine section disposed on the edge, wherein the second piece is urged against the first piece, thereby the spine section forming a specific area on the edge for indexing.

### FIELD OF THE INVENTION

The present invention is related to a spine-indexing device and more particularly, to a spine-indexing device with a paper holder, a portfolio, a diary, a PP file or the like.

### BACKGROUND OF THE INVENTION

Index divider sheets with insertable index tabs have long been in use, primarily for placement in three-ring loose-leaf binders. Annual sales of such insertable index tab sheets are estimated at between 40 million and 50 million dollars, at wholesale. Such index tabs are well known to millions of school children and businessmen, who use them in dividing notebooks according to school subjects, reports according to chapters, and presentations according to sections, as well as any other use where a collection of materials must be subdivided into sections that can be easily accessed.

Please refer to FIG. 1. FIG. 1 illustrates one type of prior art indexing system with plural tabular index divider sheets. The tabular index divider sheet 10 of the prior art consists of a paper divider sheet 12 generally of standard 8½ inch by 11 inch size but also available in other sizes, and a tabular index part 13 extending from one edge of the paper divider sheet 12 for indexing. According to the prior art, when plural tabular index divider sheets 10 are put together in a holder 14 and the holder 14 is put on a shelf, we can't directly distinguish those tabular index divider sheets 10 of the holder 14 according to the tabular index parts 13 because all tabular index parts 13 are closed together and can't be seen in the spine-direction of the holder 14.

Therefore, it is tried to rectify this drawback by the present applicant. The invention provides a spine-indexing device for indexing easily in the vertical direction even though the spine-indexing device is closed or put on a shelf.

### SUMMARY OF THE INVENTION

It is therefore a primary objective of the present invention to provide a spine-indexing device for indexing easily in the vertical direction even though the spine-indexing device is closed or put on a shelf.

According to the present invention, the spine-indexing device includes a first piece having an edge, a second piece extending from the edge; and a spine section disposed on the edge, wherein the second piece is urged against the first piece, thereby the spine section forming a specific area on the edge for indexing.

Certainly, the spine-indexing device can be a divider sheet.

Certainly, the spine-indexing device can be a paper holder.

Certainly, the spine-indexing device can be a portfolio.

Certainly, the spine-indexing device can be a diary.

Certainly, the spine-indexing device can be a PP file.

Certainly, the first piece and the second piece can be secured together.

Certainly, the spine section can be formed by means of pressing.

Preferably, the spine section has a particular shape.

Certainly, the specific area can be a vertical area.

Certainly, the first piece, the second piece and the spine section can be of a unity.

According to the present invention, the indexing device includes a sheet having an edge, and an indexing area disposed on the edge.

It is therefore a secondary objective of the present invention to provide a spine-indexing system for indexing easily in the vertical direction even though the spine-indexing system is closed or put on a shelf

According to the present invention, the spine-indexing system includes a case having a containing region, plural spine-indexing sheets disposed in the case for partitioning the containing region into plural specific regions, wherein each the spine-indexing sheet includes a first piece having an edge, a second piece extending from the edge, and a spine section disposed on the edge, wherein the second piece is secured against the first piece, thereby the spine section forming a specific area on the edge for indexing.

Preferably, the spine section is formed by means of pressing.

Preferably, the spine section has a particular shape.

Certainly, the specific area can be a vertical area.

Certainly, the first piece, the second piece and the spine section can be of a unity.

It is therefore another objective of the present invention to provide an indexing case for indexing easily in the vertical direction even though the indexing case is put on a shelf.

According to the present invention, the indexing case includes a case body having an opening and side wall having a free edge, and an indexing area disposed on the free edge for indexing the case.

Preferably, the indexing area has a particular shape.

Certainly, the indexing area can be a vertical area.

The foregoing and other features and advantages of the present invention will be more clearly understood through the following descriptions with reference to the drawings, wherein:

### BRIEF DESCRIPTION OF THE DRAWING

FIG. 1 illustrates a tab indexing system according to the prior art;

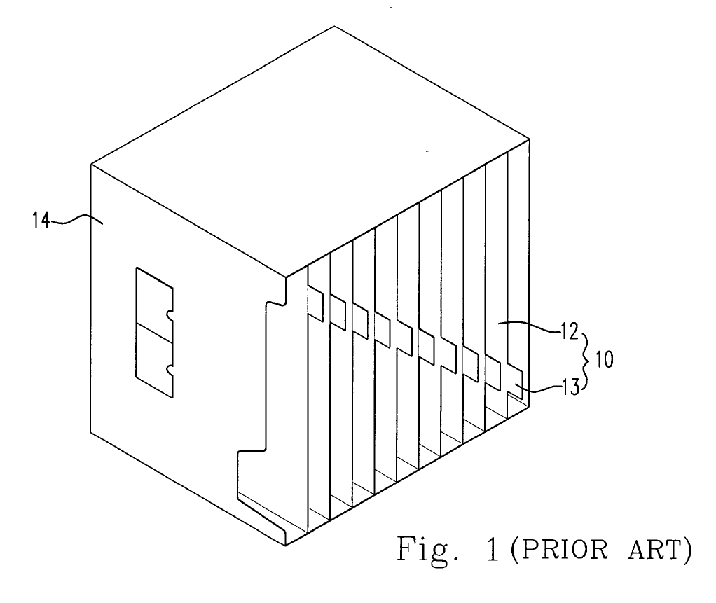

FIG. 2 illustrates a spine-indexing device according to the present invention;

FIG. 3 illustrates a spine-indexing system according to the present invention;

FIG. 4 illustrate another spine-indexing system according to the present invention; and

FIG. 5 illustrates an indexing system having plural indexing cases according to the present invention.

### DETAILED DESCRIPTION OF THE PREFERRED EMBODIMENTS

The present invention to provide a spine-indexing device for indexing easily in the vertical direction when a stationary with the spine indexing device is put on a shelf.

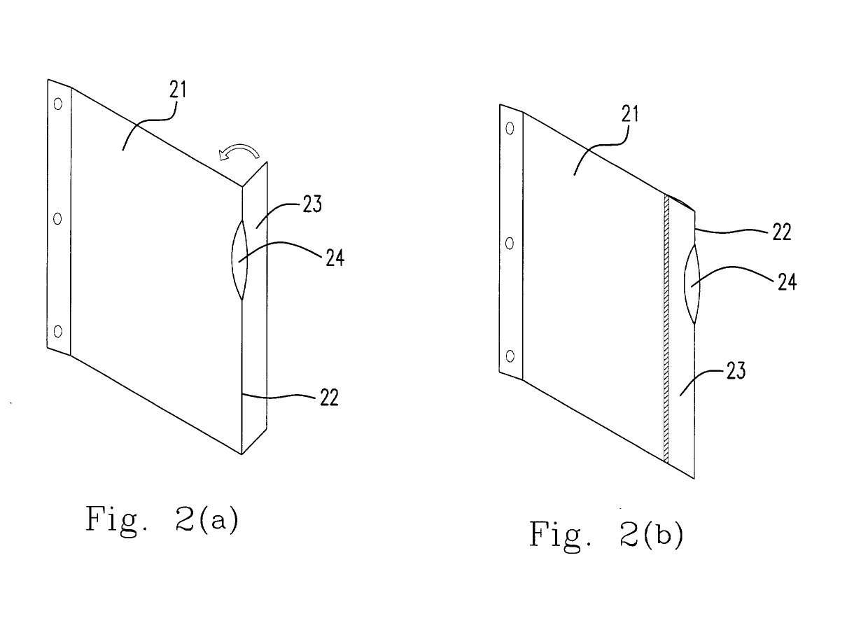

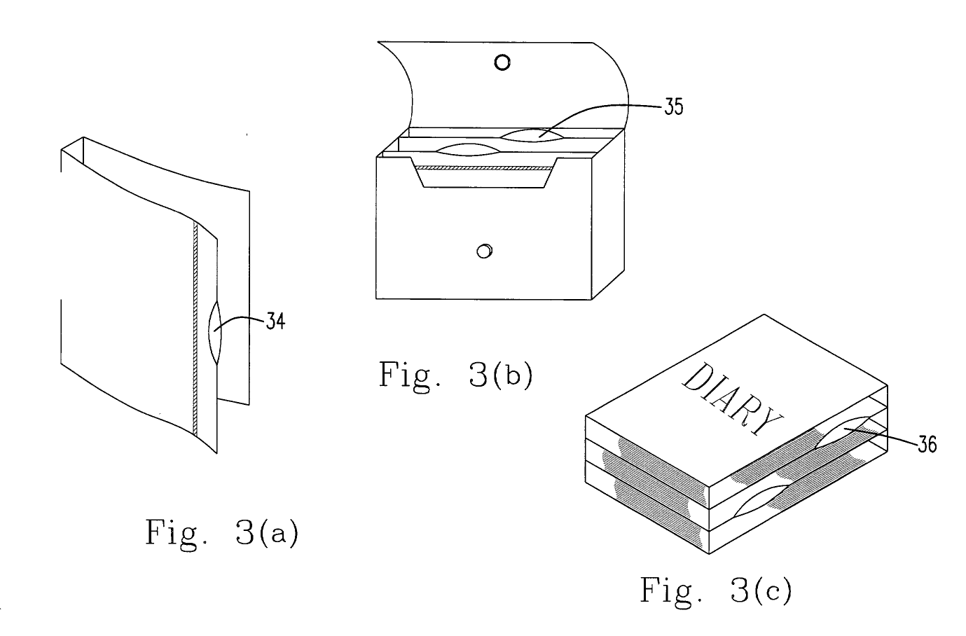

Please refer to FIG. 2. It illustrates a spine-indexing device of a first objective of the present invention. FIG. 2(a) illustrates the spine-indexing device including a first piece 21 having an edge 22, a second piece 23 extending from the edge 22, and a spine section 24 disposed on the edge 22. FIG. 2(b) illustrates the second piece 23 urged against the first piece 21, thereby the spine section 24 forming a specific area on the edge 22 for indexing. Meanwhile the specific area is a vertical area. In FIG. 2, the spine-indexing device of the present invention is applied in a divider sheet. Certainly, the spine-indexing device can be used in a paper holder, a portfolio, a diary, a PP file or the like. As shown in FIG. 3, the spine-indexing devices 34, 35, 36 are applied in several stationeries.

According to the present invention, the first piece 21 and the second piece 23 can be secured together. Certainly, the spine section 24 has a particular shape and can be formed by means of pressing. The first piece 21, the second piece 23 and the spine section 24 are of a unity.

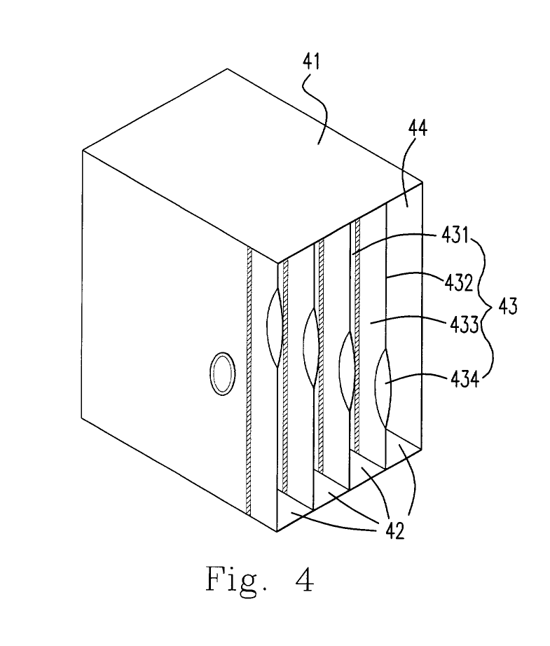

Please refer to FIG. 4. It illustrates a spine-indexing system according to the present invention. The spine-indexing system includes a case 41 having a containing region 42, plural spine-indexing sheets 43 disposed in the case 41 for partitioning the containing region 42 into plural specific regions 44, wherein each the spine-indexing sheet 43 includes a first piece 431 having an edge 432, a second piece 433 extending from the edge 432, and a spine section 434 disposed on the edge 432, wherein the second piece 433 is secured against the first piece 431, thereby the spine section 434 forming a specific area on the edge for indexing.

It is therefore another objective of the present invention to provide an indexing case for indexing easily in the vertical direction even though the indexing case is put on a shelf.

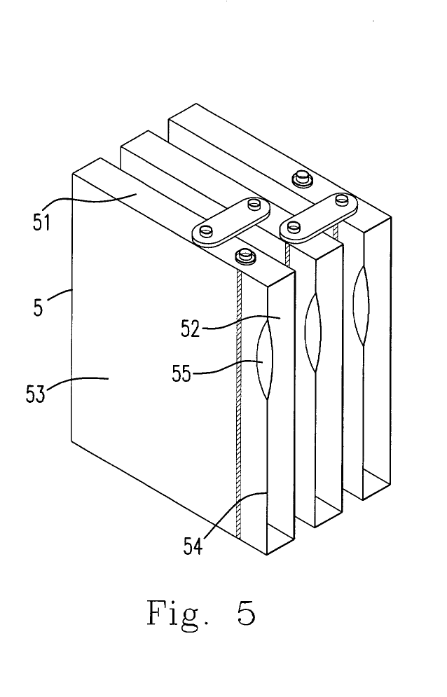

FIG. 5 illustrates another embodiment of the spine-indexing system according the present invention. The system includes plural indexing cases 5, wherein each indexing case 5 include a case body 51 having an opening 52 and side wall 53 having a free edge 54, and an indexing area 55 disposed on the free edge 54 for indexing the case 5. In this embodiment, each indexing case 5 can be used respectively or be combined to form a united indexing system.

According to the present invention, a spine-indexing device is provided. The spine-indexing device can be applied in several stationeries. For the stationeries having the spine-indexing device, it is easy to be distinguished according to the spine-indexing device even though the stationeries are closed or put on a shelf.

While the invention has been described in terms of what are presently considered to be the most practical and preferred embodiments, it is to be understood that the invention need not to be limited to the disclosed embodiment. On the contrary, it is intended to cover various modifications and similar arrangements included within the spirit and scope of the appended claims, which are to be accorded with the broadest interpretation so as to encompass all such modifications and similar structures.

What is claimed is:

1. A spine-indexing device comprising:
a first piece having an edge;
a second piece extending from said edge; and
a spine section disposed on said edge, wherein said second piece is urged against said first piece, thereby said spine section forming a specific area on said edge for indexing.

2. The spine-indexing device according to claim 1, wherein said spine-indexing device is a divider sheet.

3. The spine-indexing device according to claim 1, wherein said spine-indexing device is a paper holder.

4. The spine-indexing device according to claim 1 wherein said spine-indexing device is a portfolio.

5. The spine-indexing device according to claim 1 wherein said spine-indexing device is a diary.

6. The spine-indexing device according to claim 1 wherein said spine-indexing device is a PP file.

7. The spine-indexing device according to claim 1 wherein said first piece and said second piece are secured together.

8. The spine-indexing device according to claim 1 wherein said spine section is formed by means of pressing.

9. The spine-indexing device according to claim 1 wherein said spine section has a particular shape.

10. The spine-indexing device according to claim 1 wherein said specific area is a vertical area.

11. The spine-indexing device according to claim 1 wherein said first piece, said second piece and said spine section are of a unity.

12. A spine-indexing system comprising:
a case having a containing region;
plural spine-indexing sheets disposed in said case for partitioning said containing region into plural specific regions, wherein each said spine-indexing sheet comprises:
a first piece having an edge;
a second piece extending from said edge; and
a spine section disposed on said edge, wherein said second piece is secured against said first piece, thereby said spine section forming a specific area on said edge for indexing.

13. The spine-indexing system according to claim 12 wherein said spine section is formed by means of pressing.

14. The spine-indexing system according to claim 12 wherein said spine section has a particular shape.

15. The spine-indexing system according to claim 12 wherein said specific area is a vertical area.

16. The spine-indexing system according to claim 12 wherein said first piece, said second piece and said spine section are of a unity.

17. An indexing case comprising:
a case body having an opening and side wall having a free edge; and
an indexing area disposed on said free edge for indexing said case.

18. The indexing case according to claim 17 wherein said indexing area has a particular shape.

19. The indexing case according to claim 17 wherein said indexing area is a vertical area.

20. An indexing device comprising:
a sheet having an edge; and
an indexing area disposed on said edge.

21. The indexing device according to claim 20 being a divider sheet.
